(19) United States
(12) Patent Application Publication
(10) Pub. No.: US 2007/0152187 A1
(43) Pub. Date: Jul. 5, 2007

(54) Chlorine Dioxide Stable Solution Production Process

(75) Inventor: Claudio Truchlaeft, Fortaleza, CE (BR)

Correspondence Address: SMITH HOPEN, PA, 180 PINE AVENUE NORTH, OLDSMAR, FL, 34677, US

(73) Assignee: BERACA SABARA QUIMICOS E INGREDIENTES LTDA., Itapissuma PE (BR)

(21) Appl. No.: 11/306,578

(22) Filed: Jan. 3, 2006

(51) Int. Cl. C01B 13/02

(52) U.S. Cl. 252/186.21

(57) ABSTRACT

Production process of chlorine dioxide stable solution that occurs in two phases of pH control, the first phase being an acid one and the second phase a basic one, with two distinct reactors, one for generation of chlorine dioxide and the other for stabilization, the first one being operated under vacuum and the second one under atmospheric pressure. The resulting solution then contains up to 6% chlorine dioxide that becomes active when pH is reduced to a range of 6.5 to 7.5 at the application moment.

### TECHNICAL FIELD

The present invention is the result of studies and researches aiming at reaching a chlorine dioxide stable solution production process in such a way that the obtained stability is extended for a long period of time and that it turns into a product of easy application, transportation, storage and as well as an economically viable product.

Up to the beginning of last century chlorine dioxide was nothing but a laboratory curiosity not having a practical application chiefly owing to the difficulties in its handling. By passing time it was found that chlorine dioxide was an excellent bactericide; however, its application is still restricted due to a few problems it bears. Chlorine dioxide in gaseous form is extremely unstable once by the incidence of light its molecules are broken down thus giving away chlorine gas and oxygen with a large amount of heat release that makes it impossible to be transported or applied in the gaseous form.

On the other hand watery solutions are extremely volatile and do not admit concentrations high enough to be economically viable. Solutions are unstable concerning to contents and depending on temperature they might degrade within a few days. In view of this chlorine dioxide needs to be produced at the application site but even these local productions have their difficulties thus requiring an infrastructure that is very large with regards to equipments, transportation of acid products, electric energy and so on.

For high levels of consumption like those ones in the application of paper whitening processing plants a local production is not a problem but as for small application operations as those in the water disinfection operations it becomes unviable.

### PRIOR ART

Many studies were carried out and many patent applications were filed aiming at solving these problems; however, very little was achieved as economically viable and many of patent applications that matured into letters-patents are now into public use. Notwithstanding, one of said granted patent faces such tough issue. It is the U.S. Pat. No. 3,278,447 granted on Oct. 11, 1966 under the title “Process for Stabilizing Chlorine Dioxide Solution” issued to Thomas P. McNicholas, Greenville, the one that became itself the starting point for studies and development of the application now being filed with the purpose of making it viable both in the economic and environmental aspects.

In a way of explaining it following it is described the matter taught in Thomas P. McNicholas' patent:

Said patent deals with stabilization with perchlorate, sodium perborate or a sodium carbonate solution in water wherein chlorine dioxide is bubbled in a continuous and controlled way until obtaining a chlorine dioxide stable solution with contents of up to 6% active; such a patent further discusses a concern about the role of active oxygen in the presence of perchlorate, perborate, hydrogen peroxide and ozone. Furthermore said patent teaches several general and basic formulations without having a concern on describing a specific production process. Said granted patent does not concern with a specific gaseous chlorine dioxide production process and is aimed only at stabilization; however, this slow mixture of stabilizing agent process causes a lack of homogeneousity in the pH and in the concentration control in the stabilization reactor due to the bubbling process.

### DESCRIPTION OF THE INVENTION

The chlorine dioxide stable solution production process object in this present invention in a comparative relation with Thomas McNicholas' granted patent and taking into consideration the laboratory studies that were carried out by the present patent applicant is aimed at achieving:

a production process not by a bubbling activity of chlorine dioxide, but instead a production process carried out through injection under high vacuum wherein part of the required oxygen is originated from the production phase of chlorine dioxide that is called acid phase.

a chlorine dioxide production process that is unified with the process that generates a stabilized solution with control of reactions that are simultaneously controlled by PLC.

a hydrogen peroxide dosage with a sodium carbonate dosage that are separated from each other;

a chlorine dioxide reactor without the need for a heating system;

a weak acid liquor separation system that is forwarded on for regeneration and further reuse.

a reactor automatic washing system that is aimed at avoiding incrustations during the reaction;

more homogeneous pH and concentrations in the stabilization reactor thus decreasing losses during evaporations or gases not being absorbed in the bubbling system.

The process takes place in two phases of pH control and the first phase is an acid one, being the second phase a basic one with two distinct reactors, one for generation of chlorine dioxide and the other for stabilization; the first reactor is operated by vacuum and the second one is operated by atmospheric pressure.

The first acid phase is operated by vacuum for the generation of chlorine dioxide—reaction—by using the stabilized hydrogen peroxide together with the sodium chlorate and the sulphuric acid dosed in a reactor (R1) in a controlled way so as to maintain pH and concentrations constant. The result from this reaction is not only the chlorine dioxide but instead it is a mixture of gases. Oxygen, water steam and chlorine dioxide are released through the reactor upper end and water, the Na2SO4 (sodium sulphate) and sulphuric acid residues (herein called acid liquor) are drawn from reaction through the side portion of reactor and forwarded to the enrichment phase so that the same return afterwards to the reaction phase. The whole process takes place inside the reactor (R1) by controlled vacuum in such a way that the gaseous mixture be out of range from the explosion point. This reactor (R1) is willfully built into specific dimensions so as to have control of kinetics in the reaction not being suitable where a variation of production level is desired. Production variations inside a reactor might difficult the reaction control and, as a result, might difficult the control of reagent dosages and this would cause some damages in the next coming phase of stabilization.

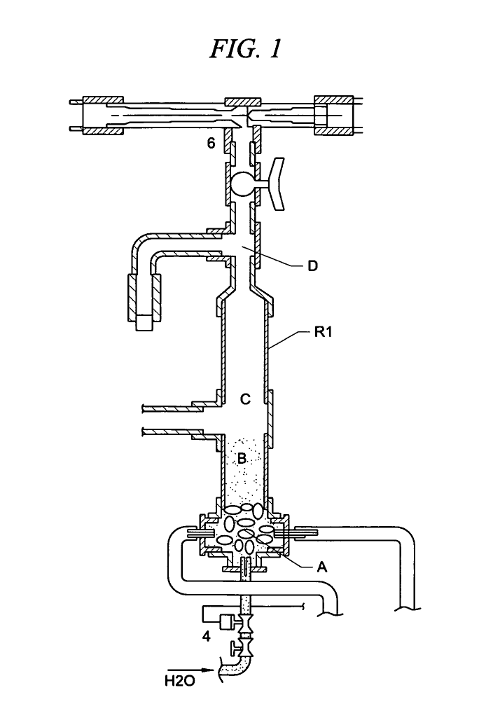

For a better understanding on how said reactor (R1) works, the reactor itself is illustrated on FIG. 1 on which the four distinct phases of operation are highlighted, being such phases as follows:

A—Reagents mixture phase

B—Reaction phase itself

C—Separation phase of gas and liquid phases

D—Suction phase

At phase A a dispersing mechanism is considered with the objective of generating high contact speed of components thus increasing the reaction speed. B phase is where the reaction itself takes place and it is where the dosage control is the first thing considered so as to obtain efficiency in a production of chlorine dioxide that takes place in an ambient of constant pH and concentrations. Phase C is where the separation of acid liquor in the gases takes place and these gases are then forwarded to solution and stabilization phase. Phase D is correspondent to the injector's throat (6) and it is here where the dimension settings of injector (6), the liquid pressure and liquid outflow rate will define the vacuum in the reaction phase from 300 to 450 mmHg. Also at the injector (6) the mixture of gases takes place with the stabilizing solution and at this point the chlorine dioxide no longer holds the explosion hazard. The acid liquor that is out from the reaction is enriched and filtered for a later return to the reaction. The basic reaction that takes place in this phase is: 2NaClO3+H2O2+H2SO4 [symbol] 2ClO2+02+NaSO4+2H2O. The presence of ions as NA+, Cl−, ++SO4 together with HClO2 is aimed at providing a favourable ambient of reaction decreasing substantially fluctuations of chlorine dioxide generation and other gases generation. Such elements are added in under low concentrations and they are called herein the reaction number 1's stabilizing agents. Chlorate mixed with stabilizing agents is dosaged through pumps (1) that are controlled by valves (2) in a combining elements or reacting compounds proportion concentration towards the interior of reactor R1. For a better understanding .the use of reactor R1 although its function and work on the process in this first phase is started by the entry of reagents sulphuric acid, sodium chlorate and hydrogen peroxide stored at containers (15) and (17) and as well as by flow rate calibrators (12) that are dosed by pumps (1) controlled by valves (2) and washing water (H2O) controlled by valves (4), providing the outflow of chlorine dioxide, oxygen, water steam and acid liquor.

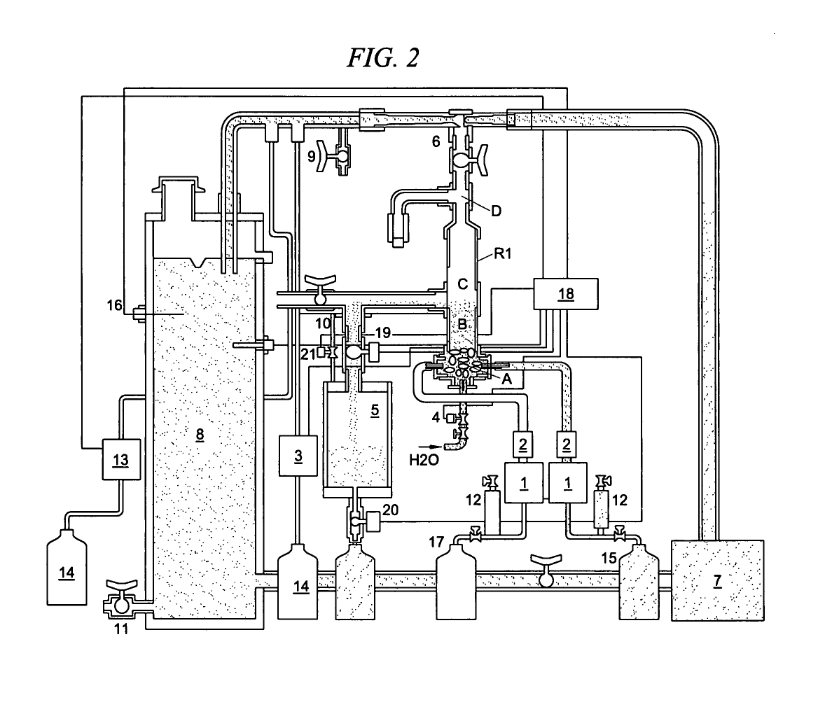

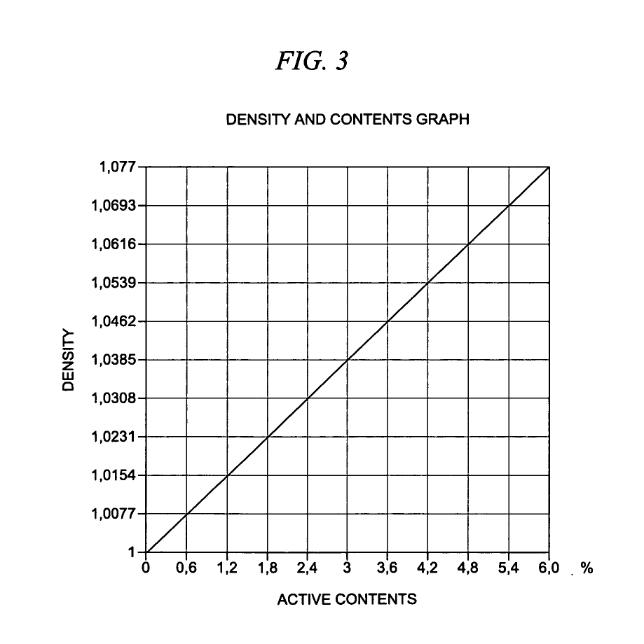

The second phase, a basic one, is operated under pressure. For a better understanding on how the chlorine dioxide stable solution is obtained in this second phase reference is made to the drawing in the flow cart on FIG. 2 comprised of a reactor (8), an injector (6) two containers (14) for injection of sodium carbonate and hydrogen peroxide solution, both containers being dosed by pumps (3) and (13). The secondary reaction occurs in a faster manner right away at the exit of injector's (6) throat in relation to the slow manner that occurs in the known bubbling operation. The stabilized solution flows from the stabilization tank to the injector (6) through a centrifugal pump (7) where the quick homogenization takes places thus minimizing losses due to gases evaporation. The dosage control is carried out by a PLC (18) that controls the dosage on the pumps (1), (3) and (13) and as well as the elimination systems of acid liquor (5) and by valves (19), (20) and (21) and by two sensors (16) that carry out the pH and colour reading for PLC (18) control. The system is complemented by valves (9) that collect samples (10) and control vacuum (11) and drainage. The routing way of stabilizing reaction is abridged to the fact that the chlorine dioxide is continuously added in demineralized water up to the start of evaporation when the carbonate with active oxygen dosage is started under an ambient temperature by which pH is controlled within a range from 7 to 10 and colour is simultaneously controlled into a slight greenish weak yellow. The reaction continues up to a content of 6% as illustrated in the contents and density graph on FIG. 3. Then the resulting solution contains up to 6% of chlorine dioxide and it becomes active when pH is reduced to a range from 6.5 to 7.5 in the moment of application. Thus, the obtained stable solution remains with very little variation for six months or longer.

What is claimed is:

1. Production process of chlorine dioxide stable solution featured by said process occurring in two phases of pH control, being the first phase an acid one and the second phase a basic one with two distinct reactors, one for chlorine dioxide generation that operates under vacuum (R1) and the second one (8) for stabilization and being operated under atmospheric pressure.

2. Production process of chlorine dioxide stable solution in accordance with claim 1, featured by the fact that on first phase on reactor R1 four distinct phases occur, being such phases: A—reagents mixture phase; B—the reaction phase itself; C—separation phase of gas and liquid phases; and D—suction phase.

3. Production process of chlorine dioxide stable solution in accordance with claim 2, featured by the fact that phase A is provided of a dispersing device that generates a high speed of reagents contact thus increasing the reaction speed.

4. Production process of chlorine dioxide stable solution in accordance with claim 2, featured by the fact that the control of dosage for obtaining the chlorine dioxide production occurs on phase B, such a control taking place in an environment of reagents with constant pH and concentrations.

5. Production process of chlorine dioxide stable solution in accordance with claim 2, featured by the fact that the separation of acid liquor from gases takes place on phase C, said gases are then forwarded to the second phase of solution and stabilization.

6. Production process of chlorine dioxide stable solution in accordance with claim 2, featured by the fact that the vacuum of reaction phase from 300 to 450 mmHg be defined on phase D through the flow rate and liquid pressure injector (6).

7. Production process of chlorine dioxide stable solution in accordance with claims 2 and 3 featured by the fact that the acid reagent, the oxidant and reducer stored in the containers (15) and (17) are dosed by pumps (1), are controlled by valves (2) together with water that is controlled by valve (4) and such acid reagents, oxidant and reducer are inserted into reactor R1.

8. Production process of chlorine dioxide stable solution in accordance with claim 1, featured by the fact that on second phase one reactor (8) is used and two containers (14) are used filled with reagents that are dosed by pumps (3) and (13).

9. Production process of chlorine dioxide stable solution in accordance with claims 1 and 8, featured by the circulation of solution from stabilizing tank to the injector (6) through a centrifugal pump (7) wherein the quick homogenization occurs.

10. Production process of chlorine dioxide stable solution in accordance with claim 1, featured by the fact that the dosage control is carried out by a PLC (18) that controls the pumps (1) (3) dosages and as well as acid liquor elimination systems (5).

11. Production process of chlorine dioxide stable solution in accordance with claims 1 and 10, featured by the fact that reactor (8) is provided with two sensors (16) that carry out the pH and colour reading for the PLC's (18) control.

12. Production process of chlorine dioxide stable solution in accordance with claim 1, featured by the stabilization reaction in which the chlorine dioxide is continuously added into demineralized water under an ambient temperature where pH is controlled within a range from 7 to 10 up to a content of 6%.
